(19) United States
(12) Patent Application Publication
(10) Pub. No.: US 2003/0142710 A1
(43) Pub. Date: Jul. 31, 2003

(54) Device for producing laser light

(76) Inventors: Jorg Meister, Korschenbroich (DE); Rene Franzen, Aachen (DE); Thomas Mitra, Langenfeld (DE); Rainer Bayer, Dusseldorf (DE)

Correspondence Address: CONNOLLY BOVE LODGE & HUTZ, LLP, 1220 N MARKET STREET, P O BOX 2207, WILMINGTON, DE, 19899

(21) Appl. No.: 10/221,918

(22) PCT Filed: Mar. 19, 2001
(86) PCT No.: PCT/DE01/01047

(51) Int. Cl. H01S 3/04; H01S 3/14; H01S 3/091; H01S 3/092

(52) U.S. Cl. 372/35; 372/39; 372/70

(57) ABSTRACT

The invention relates to a pump chamber (2), in which laser active medium is stored. The pump light is introduced into said pump chamber (2), by means of one or several fluid light guides (12), whereby the fluid used as a light guide is used as coolant for the laser active medium (1).

Solid state lasers are indispensable tools in the realm of technology, material processing and medicine. They allow precise, point-accurate and contact-free work without mechanical wearing parts such as, for example, saw blades or drills.

An aspect of central importance for a solid state laser is the laser-active medium that it contains since this is where the actual laser radiation is generated. The principle of the generation of laser radiation is stimulated emission, which was first described by Albert Einstein. By exciting the atoms in the laser-active medium, higher energy levels of the atoms are populated. If the excitation is strong enough to bring (pump) more than half of the atoms to a higher level, this is called population inversion. Ultimately, laser light is radiated as a result of the stimulated emission. In the case of a solid state laser, the laser-active medium is formed by a crystal.

The state of the art in the excitation of laser crystals is optical pumping by means of a flash lamp or with another laser system. When the excitation is carried out by means of a flash lamp, part of the emitted spectrum lies in the range of the absorption band necessary for the laser excitation. The excitation of the crystal takes place through a transversal arrangement, i.e. the laser crystal and the flash lamp lie parallel to each other. The undesired thermal output radiated by the flash lamp makes it indispensable to cool the laser crystal.

The excitation by means of another laser system can be effectuated in various arrangement options: a) longitudinal configuration, i.e. the laser that is used to pump the crystal radiates along the longitudinal axis of the crystal; b) transversal configuration, i.e. an array of laser systems is arranged transversally to the crystal. The advantage of these configurations is the narrow-band excitation of the laser transition from the basic state. This process entails a smaller loss of excitation energy than in the case of broad-band excitation with a flash lamp. The drawback is that the pumping energy, for example, in the case of longitudinal excitation, is not evenly distributed in the crystal.

The invention being presented here allows the optical excitation of a laser-active medium 1 with one or more laser systems or with other light sources 10 that are suitable for this purpose. The pump configuration used cannot be described as transversal or as longitudinal. Hereinafter, the term “diffuse pumping” will be used to describe the process being presented here. The light of the pumping light source 10 is coupled into the pumping chamber 2 via liquid light guides 12. Here, the pumping light source 10 can be made up of one or more lasers. As a result of the silvering of the end surfaces 7 of the pumping chamber 2 and due to the total reflection on the walls 6 of the pumping chamber 2, the light energy coupled in remains in the pumping chamber 2. There, it is absorbed by the laser-active medium 1, as a result of which the latter is optically excited. In this process, the laser threshold is exceeded and laser light 11 is radiated by the laser-active medium 1.

In the pumping chamber 2, the laser-active medium 1 is optically excited and cooled at the same time. Another important innovation in comparison to the state of the art is the use of the liquid (8 and 12) employed for guiding the light as the coolant for the laser-active medium 1. Hence, the liquid fed in serves as the light guide of the pumping radiation inside the liquid light guide 12 and for simultaneously cooling the laser-active medium 1 in the pumping chamber 2. Via suitably placed outlets 4, the liquid is fed back to the pump 9. It is recommended to have a closed liquid circuit in which the liquid is continuously circulated and treated. The light of the pumping light source 10 is coupled in by means of a suitable coupling device. The use of the liquid as the coolant and simultaneously as the light guide medium translates into a more compact design of the pumping chamber 2 and of the entire laser device.

The proposed invention is of special interest in view of the fact that the pumping light source 10 as well as the circulation pumping system can be kept at a physical distance from the pumping chamber 2 and thus from the actual laser-active medium 1. Consequently, it is possible to generate the laser light 11 directly where it is going to be used. A concrete example of this is laser applicators used in manufacturing equipment. With the proposed invention, the required laser energy can be generated directly at the site of the processing and does not have to fed via light guide systems, which always entail losses and/or high costs. Another important example in this context are hand-held instruments for medical use. For example, the laser-active medium 1 of a dental laser can be integrated in a space-saving manner into the hand-held instrument instead of, as was the case until now, generating the radiation externally and supplying it to the hand-held instrument by means of silvered articulated arms or other light transmission systems.

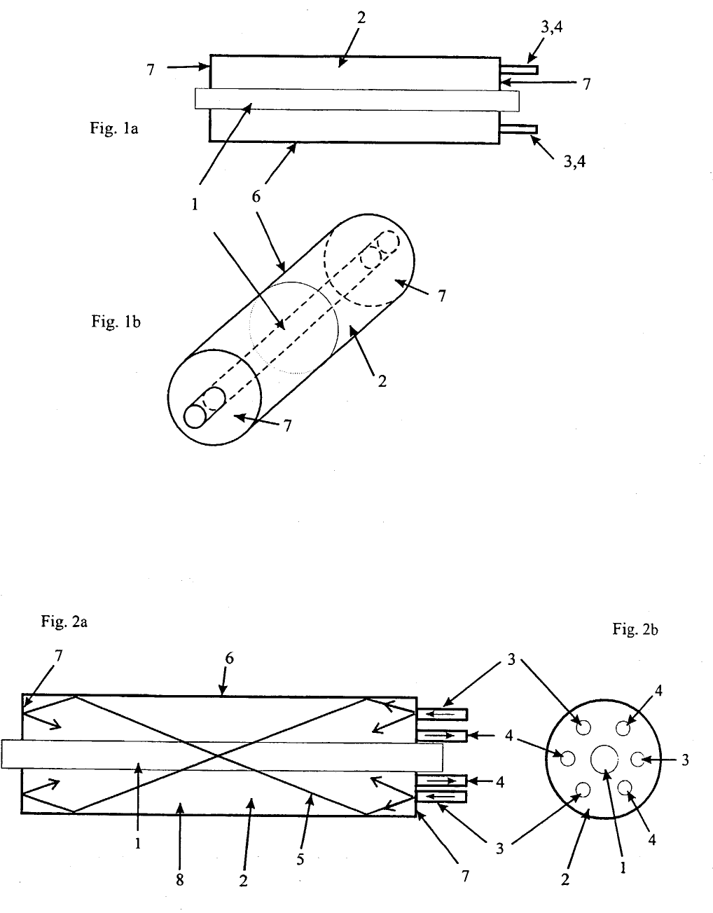

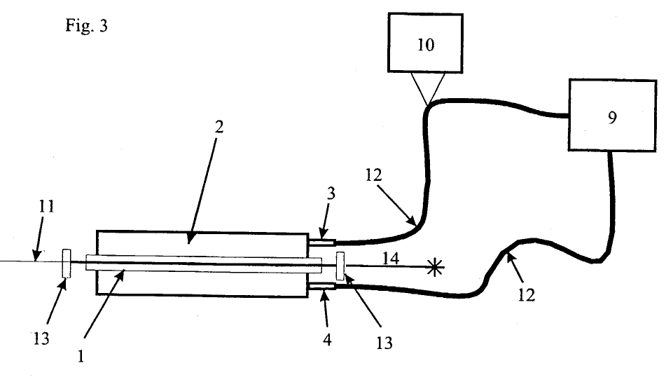

The proposed invention describes the optical excitation (optical pumping) of a laser-active medium 1 in a pumping chamber 2. A laser-active medium 1 that is arranged in the pumping chamber 2 is surrounded by a liquid that serves a) to guide light in the pumping chamber 2 and to the liquid light guides 12, and b) to protect the laser-active medium 1 from overheating and thus from being destroyed. Inlets 3 and outlets 4 appropriately positioned on the pumping chamber 2 allow the continuous circulation of the liquid. The attached FIGS. 1a, 1b, 2a, 2b and 3 show an example of a modality for effectuating the proposed invention. Additional related embodiments are conceivable. At the inlets 3, the liquid is fed in via liquid light guides 12 that make it possible to transport the liquid itself as well as the pump radiation stemming from the pumping light source 10 into the pumping chamber 2. After the pumping light has entered the pumping chamber 2, it is guided into the pumping chamber 2 due to the reflections on the side surfaces 6 of the pumping chamber 2, which are virtually parallel to one surface of the laser-active medium 1. These reflections can be achieved by means of silvering or on the basis of total internal reflection. At the end surfaces 7 of the pumping chamber 2, which can have any desired shape and which join the side surfaces 6 to each other, the radiated light can likewise be reflected. The reflections on the side surfaces 6 and/or on the end surfaces 7 serve the purpose of uniformly distributing the radiated pumping light within the pumping chamber 2, so that this light serves for the optical excitation (diffuse pumping) of the laser-active medium 1. Owing to this effect, the laser-active medium 1 undergoes a population inversion and, in turn, emits laser light 11 if a suitable resonator 13 is present or, as an alternative to this, if the end surfaces of the laser-active medium 1 exhibit a suitable silvering.

In one embodiment of the invention, it is provided that the laser-active medium 1 is, for example, a rod-shaped solid state laser crystal whereby this can be Nd:YAG, Ho:YAG, Er:YAG, ErCr:YSGG, Er:GGG, Er:YSGG, Er:YLF or crystals doped with other rare earths.

In a preferred embodiment of the invention, it is proposed to use the liquid as the core material of the liquid light guides 12.

In a preferred embodiment of the invention, it is proposed that the liquid be used as the core material for guiding the light inside the pumping chamber 2.

In a preferred embodiment of the invention, it is proposed that the liquid be used as the coolant for the laser-active medium 1.

This allows a compact design for the pumping chamber 2 and for the entire laser device. A miniaturization of the system can be achieved, for example, in that one or both end surfaces of the laser-active medium 1 are provided with silvering, since then an external resonator 13 is no longer needed.

In an advantageous embodiment of the invention, it is proposed that the liquid for cooling and for guiding the light can consist, for example, of aqueous solutions, silicone oils or other liquids.

In an advantageous embodiment of the invention, it is proposed that the laser-active medium 1 be configured as a fiber laser. The embodiment of the laser-active medium as a fiber laser has the advantage that it can be coiled and thus designed to be very long without appreciably changing the length that is crucial for the reinforcement of the laser radiation 11. Options as the host material for the fiber laser include, among others, glass doped with rare earths.

In a preferred embodiment of the invention, the laser-active medium 1 is doped with erbium. In this way, laser radiation 11 having wavelengths of about 3 μm can be generated, which are highly effective especially for photo-ablation of biological tissue.

In another embodiment, the laser-active medium 1 is doped with holmium so that laser radiation 11 having wavelengths of about 2 μm can be generated.

Additional advantageous embodiments of the invention ensue from doping the laser-active medium 1 with neodymium so that wavelengths of about 1 μm can be generated.

List of Reference Numerals

1. laser-active medium

2. pumping chamber

3. inlets

4. outlets

5. example of a beam path of the pump radiation

6. side surfaces of the pumping chamber 2

7. end surfaces of the pumping chamber 2

8. interior of the pumping chamber 2 (filled with liquid)

9. pump for the liquid

10. pumping light source

11. generated laser light

12. liquid light guide/tube

13. silvering of an external resonator

14. optional longitudinal pumping light

1. A pumping chamber 2, characterized in that it holds a laser-active medium 1.

2. The pumping chamber 2 according to claim 1, whereby it has any desired number of appropriately positioned inlets 3 and outlets 4 through which a liquid flows. Among others, the liquid can consist of aqueous solutions, silicone oils and/or other liquids. In order to generate the total internal reflection on the inside 6 of the pumping chamber 2, there is a need for a difference in the index of refraction between the chamber material of the pumping chamber 2 and the liquid, whereby the index of refraction (refractive index) of the liquid has to be higher than that of the chamber material of the pumping chamber 2.

3. The pumping chamber 2 according to claim 1, whereby the insides 6 of the pumping chamber 2 are provided with silvering.

4. The pumping chamber 2 according to claims 1, 2 or 3, characterized in that one or both end surfaces 7 of the pumping chamber 2 are provided with silvering.

5. The pumping chamber 2 according to one of claims 1 to 4, characterized in that the laser-active medium 1 held therein is cooled by the liquid.

6. The pumping chamber 2 according to one of claims 1 to 5, characterized in that the laser-active medium 1 held therein is cleansed by the liquid.

7. The pumping chamber 2 according to one of claims 1 to 6, characterized in that one or both of the end surfaces of the laser-active medium 1 are provided with silvering.

8. The pumping chamber 2 according to one of claims 1 to 7, characterized in that the laser-active medium 1 is embedded in an external resonator 13.

9. The pumping chamber 2 according to one of claims 1 to 8, characterized in that the laser-active medium 1 can be Nd:YAG, Nd:YLF, Ho:YAG, Er:YAG, ErCr:YSGG, Er:YSGG, Er:GGG or crystals doped with other rare earths.

10. The pumping chamber 2 according to one of claims 1 to 9, characterized in that the host material of the laser-active medium 1 is a YAG crystal.

11. The pumping chamber 2 according to one of claims 1 to 9, characterized in that the host material of the laser-active medium 1 is a GGG, GSGG or YSGG crystal.

12. The pumping chamber 2 according to one of claims 1 to 11, characterized in that the laser-active medium 1 is configured as a fiber laser.

13. The pumping chamber 2 according to one of claims 1 to 12, characterized in that the laser-active medium 1 of the fiber laser is made of glass doped with rare earths.

14. The pumping chamber 2 according to one of claims 1 to 13, characterized in that the laser-active medium 1 is doped with holmium.

15. The pumping chamber 2 according to one of claims 1 to 14, characterized in that the laser-active medium 1 is doped with erbium.

16. The pumping chamber 2 according to one of claims 1 to 15, characterized in that the laser-active medium 1 is doped with thulium.

17. The pumping chamber 2 according to one of claims 1 to 16, characterized in that the laser-active medium 1 is doped with neodymium.

18. The pumping chamber 2 according to one of claims 1 to 17, characterized in that the energy necessary for optical excitation is supplied to the pumping chamber 2 via one or more light guides 12.

19. The pumping chamber 2 according to one of claims 1 to 18, characterized in that the liquid is fed into the pumping chamber 2 via one or more light guides 12.

20. The pumping chamber 2 according to one of claims 1 to 19, characterized in that another light guide 14 longitudinally excites the laser-active medium 1.
